(19) United States
(12) Patent Application Publication
(10) Pub. No.: US 2004/0100638 A1
(43) Pub. Date: May 27, 2004

(54) Correcting surface contour of a non-rigid object through control of surface residual stress

(75) Inventors: James A. Folta, Livermore, CA (US); Kenneth L. Blaedel, Dublin, CA (US); John S. Taylor, Livermore, CA (US)

Correspondence Address: Alan H. Thompson, Deputy Laboratory Counsel For Intellectual, Property, Lawrence Livermore National Laboratory, P.O. Box 808, L-703, Livermore, CA, 94551, US

(73) Assignee: The Regents of the University of California.

(21) Appl. No.: 10/305,598

(22) Filed: Nov. 27, 2002

(51) Int. Cl. G01B 11/24

(52) U.S. Cl. 356/601

(57) ABSTRACT

A method is described for deforming a non-rigid object in order to correct small errors in the contour of its functional surface(s). This method causes the deformation of the object, and in particular, the object's functional surface, by altering the surface tractions or surface stresses on any surface of the part including a non-functional one.

The United States Government has rights in this invention pursuant to Contract No. W-7405-ENG-48 between the United States Department of Energy and the University of California for the operation of Lawrence Livermore National Laboratory.

### BACKGROUND OF THE INVENTION

1. Field of the Invention

The present invention relates to the shaping of the surface of objects, and more specifically, it relates to techniques for correcting the surface errors of reflective surfaces.

2. Description of Related Art

A number of applications exist where it is desirable to minimize the weight, or the volume of a component such as an optic, and at the same time maintain a precisely defined surface contour. These contradictory desires simultaneously occur in the design of large optics for space uses such as the Hubble telescope, as well as in large optics for ground use such as the CELT telescope.

In other cases, a certain stiffness of an object is required and its contour must be fabricated through other than external constraints, e.g., the flatness of photomasks for use in EUVL.

It is therefore desirable to provide techniques for manipulating the contour of non-rigid objects.

### SUMMARY OF THE INVENTION

It is an object of the present invention to provide techniques that correct the shape of optics that have departures from a specified shape.

This and other objects will be apparent based on the disclosure herein.

One embodiment begins with the application of a coating on one surface of the object, preferably one of its non-functional surfaces, for example, the rear surface of a mirror. The coating is applied at a nominal residual stress, either tensile or compressive as appropriate. The coating thus causes the surface to deform in response to the residual stress of the coating. The surface contour is measured and the departure from its specified shape is noted. The measurement will indicate errors in the contour of the function surface, which are due to both the original shaping of that surface, and to the presence of the coating added to the object. The residual stress of the coating is then altered over the area of the stressed coating in a pattern so as to reduce the contour error of the functional surface. Thus, a spatially varying residual stress over a surface of the part is used to correct for contour error of the functional surface.

In a second embodiment, the coating is applied initially with spatial gradients in its residual stress to nominally shape the functional surface to the desired shape. If necessary, final shaping is done by further altering of the stress, as described above.

In a third embodiment, a stressed coating is not applied, but rather a spatially varying stress is imposed directly on the substrate by processes such as laser-peening. In this manner, the surface layer of the bulk material serves the same role as an added layer in that it is used to manifest a desired distribution of stress.

The invention has many uses, including correcting errors in the flatness of photomasks, for example, for Extreme Ultraviolet Lithography, contouring non-rigid optical mirrors or segments of mirrors that compose space telescopes, and for shaping sheet-metal or other thin parts where residual stress that results from the forming process causes unacceptable error in the freestanding part. This invention could compensate for errors associated with difficult-to-predict “spring-back.”

### BRIEF DESCRIPTION OF THE DRAWINGS

FIG. 1 shows a non-flat plat having a functional surface and a nonfunctional surface.

FIG. 2 shows a plate with a uniformly stressed tensile layer added to the rear surface.

FIG. 3 illustrates the plate after selectively annealing the stressed layer.

### DETAILED DESCRIPTION OF THE PREFERRED EMBODIMENTS

A method is described for deforming a non-rigid object in order to correct small errors in the contour of its functional surface. A non-rigid object is one that bends or otherwise deforms when subjected to forces or stresses are applied. All objects can be considered “non-rigid” in that they all deform to some extent when external forces are applied. The practical distinction relevant to this invention is that for a non-rigid object, the amount of bending or deformation exhibited must be sufficiently large to be useful in correcting the surface errors. Conversely, an object that does not bend or deform when a reasonable amount of force or stress is applied can be considered “rigid”.

A measurement is made of the error in the contour of the functional surface, that is, its departure from the specified shape. The errors could be measured by various instruments, such as an interferometer, coordinate measuring machine, or stylus-profiling instrument. The measured contour error is input into a structural analysis program¹ that calculates the required surface tractions (such as stress distribution within a coating layer) of one or more of the object's surfaces that would deform the object so as to minimize the error in the contour of the functional surface. The contour error is then corrected by altering the surface traction according to the calculated prescription. In some cases it may be sufficient for the applied stress to be uniform, such as in a case where it is desired to impart a near-spherical bending to the object. In the general case, which comprises many important applications, the desired stress distribution would not be spatially uniform.

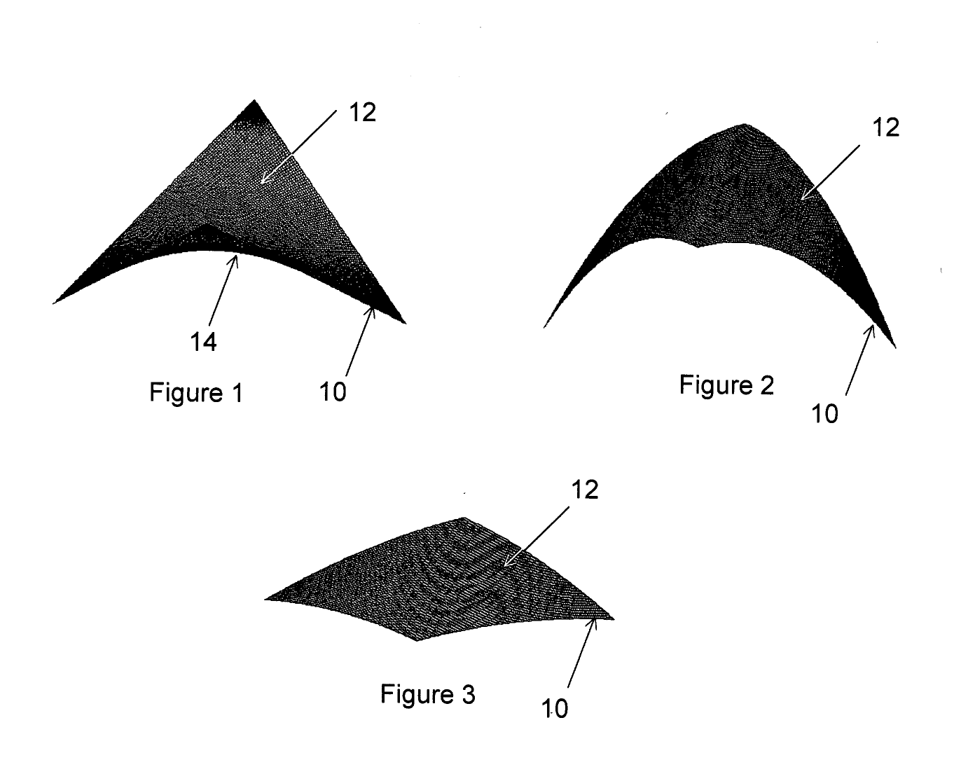

FIG. 1 shows a non-flat plat 10 having a functional surface 12 and a nonfunctional surface 14. One embodiment of the method begins with the application of a thin or thick coating on a surface of the object, preferably one of its non-functional surfaces, for example, the rear surface of a mirror, opposite functional surface 12 in FIG. 2. The coating thickness may be very thin, i.e., much less than 1% of the thickness of the object, or a larger fraction of the object's thickness. The coating is applied with residual stress, such as being in compression or tension, by any of a variety of methods, e.g., ion-beam deposition or sputtering, which generally applies a thin film with a selectable controllable and nominally uniform residual stress. The coating would be deposited in such a manner that it would possess a nominally uniform residual stress that has magnitude greater than the maximum amount needed to bring the shape of the object into the desired form. The coating thus causes the surface to deform in a predictable fashion as a result of the residual stress of the coating, but because the coating was applied at a nominal and uniform value, it will not satisfy the prescription for the spatially varying solution calculated above. The surface contour must be re-measured and the departure from its specified shape is again noted. The re-measured contour error is again input into a structural analysis program that calculates the required spatially varying surface traction of the object's coated surface that would deform the object so as to mninimize the error in the contour of the functional surface. The contour error is then corrected by altering the residual surface traction, according to the re-calculated prescription, by one of the following methods, which differ only in the specific mechanism of how they alter traction.

A first technique for spatially altering the surface traction imparted by the stressed coating is by annealing or partially annealing the stressed coating over small areas by an energy beam such as by laser heating, electron-beam heating, application of heat with a small torch or other methods. FIG. 3 illustrates the plate after selectively annealing the stressed layer. The area of the heated footprint should be much smaller than the area of the coated surface. By moving the energy beam over the coated surface in a controlled pattern and varying energy of the beam or the amount of time that the beam dwells over any particular location, the uniform residual stress of the thin film is changed to conform to that prescribed by the calculation.

A requirement for using this invention is to possess a means of controlling the stress exerted by the coating. The knowledge required to do this can be rudimentary, such as “heating the coating lowers stress” or “thicker coatings exert more bending force”. This level of knowledge may be useful for the case of an operator making shape corrections applying a hand-held heat source to a coating and he can see the results of his actions on a measurement display. The precision to which the shape can be controlled would be enhanced by a more detailed knowledge of the relationship between control parameters and the resultant residual stress or bending forces. An example of this knowledge could be the connection relationship between annealing temperature and residual stress. This level of knowledge may be useful for the case of improving the shape of an optical element and the application of the heat source is robotically controlled. It may be necessary to perform a calibration experiment where the amount of resultant stress is measured as a function of control parameters. A calibration test may comprise a standard test of thin film coating stress by measuring the curvature change of a silicon wafer due to the deposition of a coating.

In a specific example of this technique, the stress of thin film multilayer coatings of alternating layers of molybdenum and silicon has been characterized to be 380 MPa (compressive). It has also been shown that thermal annealing of the Mo/Si films on silicon wafers reduces the stress. Annealing at 200 ° C. reduces the stress to about 150 MPa, and annealing at 300 ° C. reduces the stress to near zero. Therefore local heating of the surface by any number of means will provide a local variation in stress to deform the shape of the substrate.

A second technique of spatially altering the traction imparted by a stressed coating is by removing a varying fraction of the thickness of the stressed coating, such as by laser ablation, abrasive methods such as grinding or abrasive blasting, or etching. The area of the material-removal footprint should be much smaller than the area of the coated surface. By patterning the material removal over the coated surface, the uniform thickness of the thin film is changed such that the resultant tractions imparted to the object conform to that prescribed by the back-calculation. Again, the level of knowledge required to do this can range from rudimentary to more detailed.

A third technique of spatially altering the surface tractions imparted to the object is to deposit a stressed coating with varying thickness as prescribed by the calculation. This requires a deposition footprint that is much smaller than the area of the coated surface. By moving the deposition footprint over the coated surface in a controlled pattern, the thickness of the stressed film is changed to impart a surface traction to the object that conforms to that prescribed by the calculation. The level of knowledge required to do this can range from rudimentary to detailed, depending on the level of precision that is required. The end result of this embodiment is the same as that described in the annealing step of the previous embodiment: a stressed deposition of varying thickness in accordance with the calculation that prescribes the spatially varying tractions required to correct the contour error of the functional surface.

In a fourth embodiment of this method, a stressed coating is not applied, but rather a spatially varying stress is imposed directly on the object's surface by processes such as shot-peening or laser-peening. By moving the peening footprint over the surface in a controlled pattern, a spatially varying residual stress is imparted to the object's surface that conforms to that prescribed by the back-calculation. The knowledge required to accomplish this ranges from rudimentary to detailed, depending on the level of precision that is required.

This method does not impose forces applied externally, such as through support connections or by adding mechanisms or electromechanical actuators, in order to deform the object. Among the advantages that derive from this is that the surface of an object can be deformed at little increase in weight or volume as compared to “warping harnesses” and other mechanisms intended to impose external forces on the objects in order to shape its surface.

In the embodiments requiring a coating, if the coating is of the same material or a material that has thermal expansion the same as the object, then this method of shaping will be insensitive to changes in temperature.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim:

1. A method for producing a desired contour on a functional surface of a non-rigid object, comprising altering surface tractions or surface stresses on a surface of said non-rigid object to produce a desired contour on a functional surface of said non-rigid object.

2. The method of claim 1, wherein the step of altering surface tractions includes:
measuring a contour of said functional surface; and
calculating the difference between said contour and a desired contour.

3. The method of claim 2, wherein the step of altering surface tractions or surface stresses comprises:
applying a residual stress coating on said surface of said object;
re-measuring said contour; and
altering said nominal residual stress coating in a pattern that reduces the contour error of a functional surface.

4. The method of claim 3, wherein said nominal residual stress coating is applied to a non-functional surfaces.

5. The method of claim 1, wherein the step of altering surface tractions or surface stresses on a surface including applying a coating to said object, wherein said coating comprises about the same thermal expansion as said object.

6. The method of claim 2, wherein the step of altering surface tractions or surface stresses comprises:
re-measuring said contour; and
applying a spatially varying residual stress coating to said object to shape said functional surface to a desired shape.

7. The method of claim 6, further comprising altering said spatially varying residual stress coating in a pattern that reduces the contour error of said functional surface.

8. The method of claim 1, wherein the step of altering surface tractions or surface stresses applying a spatially varying stress directly on said object.

9. The method of claim 1, wherein said object comprises a thin film multilayer coating.

10. The method of claim 1, wherein said object is selected from the group consisting of a photomask, a mirror and metallic object.

11. The method of claim 2, wherein the step of measuring is carried out with an instrument selected from the group consisting of an interferometer, a coordinate measuring machine and a stylus-profiling instrument.

12. The method of claim 2, further comprising inputting said difference, into a structural analysis program that calculates the required surface tractions of one or more of the object's surfaces that would deform the object so as to produce said desired contour of on said functional surface.

13. The method of claim 12, wherein said required surface tractions comprise stress distribution within a coating layer.

14. The method of claim 1, wherein the step of altering surface tractions is carried out by applying a residual stress coating to a surface of said object, wherein said coating is applied by a method selected from the group consisting of ion-beam deposition and sputtering.

15. The method of claim 14, wherein said coating is applied in such a manner that it would possess a nominally uniform residual stress that has magnitude greater than the maximum amount needed to bring the shape of said functional surface to said desired contour.

16. The method of claim 14, wherein the step of altering surface tractions or surface stresses comprises annealing or partially annealing the stressed coating.

17. The method of claim 16, wherein the step of annealing or partially annealing is carried out with an energy source selected from the group consisting of a laser beam, an electron-beam beam and a torch.

18. The method of claim 1, wherein the step of altering surface tractions or surface stresses on a surface of said non-rigid object includes removing a varying fraction of the thickness of a stressed coating applied to said object.

19. The method of claim 18, wherein the step of removing a varying fraction is carried out by a process selected from the group consisting of laser ablation, abrasion, polishing, wet etching and dry etching.

20. The method of claim 1, wherein the step of altering surface tractions or surface stresses comprises annealing or partially annealing the stressed coating.

21. An apparatus for producing a desired contour on a functional surface of a non-rigid object, comprising:
means for measuring a contour of said functional surface;
means for calculating the difference between said contour and a desired contour; and
means for altering surface tractions or surface stresses on a surface of said non-rigid object to produce said desired contour on a functional surface of said non-rigid object.

22. The apparatus of claim 21, wherein said means for altering surface tractions or surface stresses includes means for applying a spatially varying stress directly on said object.

23. The apparatus of claim 21, wherein said object comprises a thin film multilayer coating.

24. The apparatus of claim 21, wherein said object is selected from the group consisting of a photomask, a mirror and metallic object.

25. The apparatus of claim 21, wherein said means for measuring a contour of said functional surface comprises an instrument selected from the group consisting of an interferometer, a coordinate measuring machine and a stylus-profiling instrument.

26. The apparatus of claim 21, further comprising a structural analysis program that calculates from said difference the required surface tractions of one or more of the object's surfaces that would deform the object so as to produce said desired contour of on said functional surface.

27. The apparatus of claim 21, wherein said means for altering surface tractions comprises an energy source selected from the group consisting of an ion-beam source, a sputtering source, a laser beam source, an electron-beam source and a torch.
